(19) United States
(12) Patent Application Publication
(10) Pub. No.: US 2009/0284638 A1
(43) Pub. Date: Nov. 19, 2009

(54) CAMERA MODULE SPACER AND CAMERA MODULE USING SAME

(75) Inventors: WEI-HSIU CHANG, Tu-Cheng (TW); CHUN-HSIANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/166,340

(22) Filed: Jul. 2, 2008

(30) Foreign Application Priority Data
May 13, 2008 (CN) 200810301552.0

(51) Int. Cl. H04N 5/225; G02B 13/20

(52) U.S. Cl. 348/335; 359/707; 348/E05.024

(57) ABSTRACT

A camera module includes a barrel, at least two optical elements received in the barrel, a spacer disposed between the two optical elements, a holder connected to the barrel, an image sensor module, and a circuit board. The spacer has an inner side with a curvature at each point on a contour of an axial section thereof greater than 0. The image sensor module is disposed at the image side of the optical elements. The circuit board is electrically connected to the image sensor module and fixed on the holder. Because the stray light is scattered utilizing the spacer, a brightness of the light spot formed by the stray light on the image sensor module 15 is decreased. Therefore, the quality of an image captured by the camera module may be improved in comparison with the conventional camera module.

### BACKGROUND

1. Field of the Invention

The present invention generally relates to camera modules, and, in particular, to a camera module with a spacer for scattering stray light striking thereon.

2. Description of the Related Art

Conventionally, a camera module has a spacer. The spacer is disposed between two optical elements, such as two lenses, and is used for adjusting the distance between the two optical elements to optimize performance of the camera module. Referring to FIG. 4, the spacer 20 of a conventional camera module and light path of light incident on the spacer 20 are shown. The spacer 20 has a planar side 21 and during imaging, stray light may strike on the planar side 21 and be reflected onto an imaging plane of an image sensor module 30. As shown in FIG. 5, a light patch 31 may be formed on the image sensor module 30 by the reflected light. Generally, the brightness of the light patch 31 may be strong enough to decrease quality of an image captured by the camera module.

### SUMMARY

In an exemplary embodiment, a camera module includes a barrel, two optical elements received in the barrel, a spacer disposed between the two optical elements, a holder connected to the barrel, an image sensor module, and a circuit board. The spacer has an inner side with a curvature at each point on a contour of an axial section thereof greater than 0. The image sensor module is disposed at the image side of the optical elements. The circuit board is electrically connected to the image sensor module and fixed on the holder.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a schematic view of a camera module according to an exemplary embodiment of the present invention;

FIG. 2 is a light path diagram of a beam of stray light incident on an inner side of a spacer of the camera module of FIG. 1;

FIG. 3 is a schematic view of light spots formed on an image sensor module of the camera module of FIG. 1;

FIG. 4 is a schematic view of a conventional spacer and a light path diagram of a beam of stray light incident thereon; and

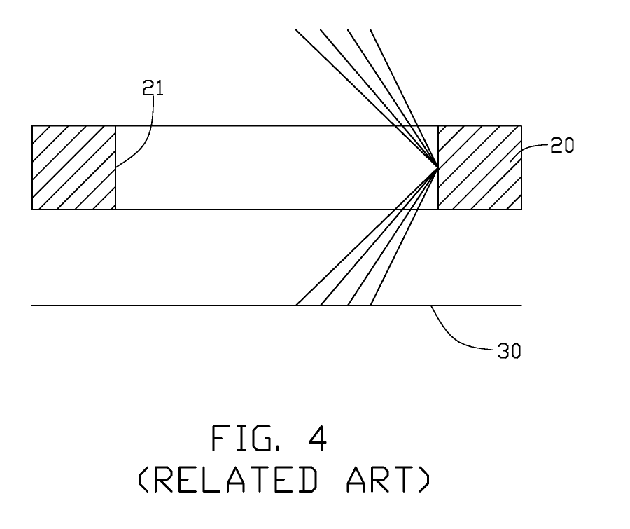

FIG. 5 is a schematic view of a light spot formed by reflected stray light on an image sensor module of FIG. 4.

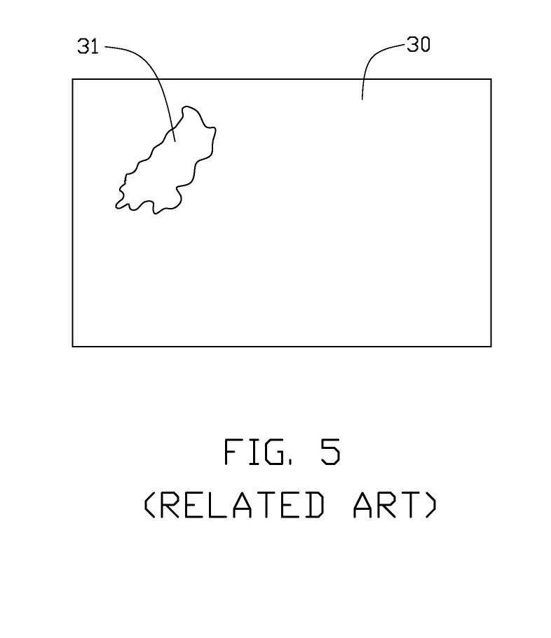

### DETAILED DESCRIPTION

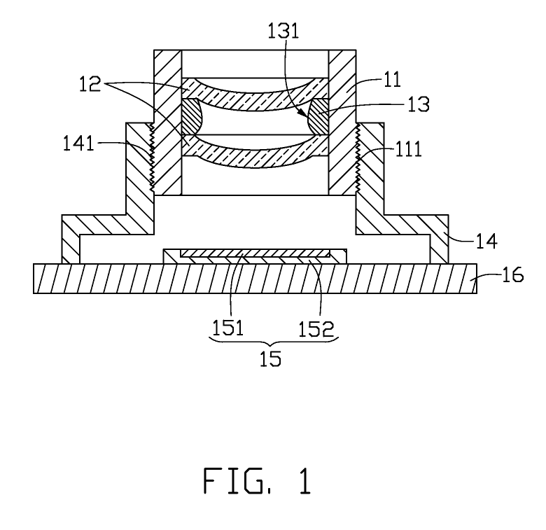

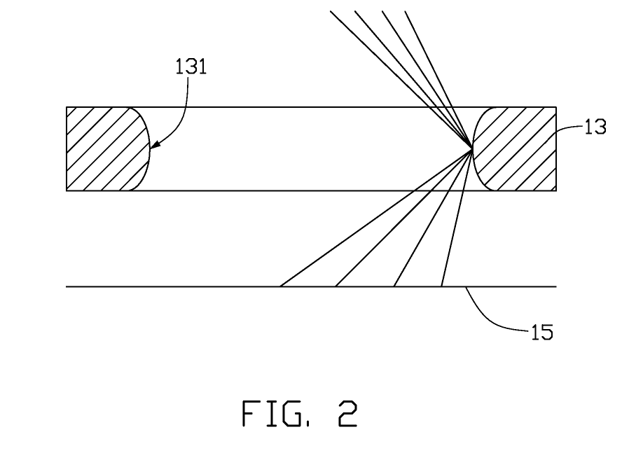

Referring to FIGS. 1 through 2, a camera module according to the exemplary embodiment is shown. The camera module includes a barrel 11, two lenses 12 received in the barrel 11, a spacer 13, a holder 14 connected to the barrel 11, an image sensor module 15, and a circuit board 16.

It should be noted that the two lenses 12 are optical elements. Understandably, the optical elements may include filters or more lenses.

An outer side of the barrel 111, where the holder 14 is disposed, defines an outer screw 111. An inner side of the holder 14 defines an inner screw thread 141 configured for engaging with the outer screw thread 111 of the barrel 11, such that the barrel 11 can be rotated to move forward and backward along a central axis of the holder 14.

The spacer 13 may be made of plastic, metal, or the like. In the present embodiment, the spacer 13 is made of metal and only one spacer 13 is disposed between the two lenses 12. The spacer 13 has a curved inner side 131. Curvature at any each point along a contour of an axial section of the inner side 131 is greater than 0. The inner side 131 can be either a convex configuration or a concave configuration. In the present embodiment, the inner side 131 is a convex configuration.

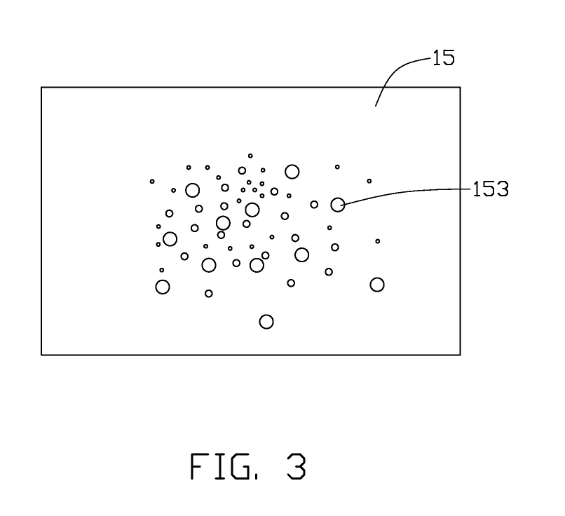

Referring to FIG. 3, a light path diagram of a beam of stray light incident on the inner side 131 of the spacer 13 is shown. The stray light strikes the inner side 131 and is reflected by the convex surface of the inner side 131 and scattered except for what is absorbed by the inner side 131. After the stray light is scattered, a brightness of the light spot formed by the stray light on the imaging plane of the image sensor module 15 is relatively dim, as shown in FIG. 3. Therefore, the quality of an image captured by the camera module is improved in comparison with the conventional camera module.

The image sensor module 15 is disposed at the image side of the lenses 12 and includes an image sensor 151 and a base 152 configured for supporting the image sensor 151 and electrically connecting to the image sensor 151. The image sensor 151 may be a charge coupled device image sensor or a complementary metal-oxide semiconductor image sensor. In the present embodiment, the image sensor 151 is a charge coupled device. The image sensor module 15 is configured for capturing images and converting the images into digital data to be processed by a processor (not shown).

The circuit board 16 may be a printed circuit board (PCB) and is fixed on the holder 14. The circuit board 16 is electronically connected to the image sensor module 15 and configured for transmitting signals generated by the image sensor module 15 to other device, such as a processor.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A spacer for a camera module, comprising:
an inner side with a curvature at each point on a contour of an axial section thereof greater than 0.

2. The spacer as claimed in claim 1, wherein the spacer is made of plastic.

3. The spacer as claimed in claim 1, wherein the spacer is made of metal.

4. The spacer as claimed in claim 1, wherein the inner side is a convex configuration.

5. The spacer as claimed in claim 1, wherein the inner side is a concave configuration.

6. A camera module, comprising:
a barrel;
two optical elements received in the barrel;
a spacer disposed between the two optical elements, the spacer having an inner side with a curvature at each point on a contour of an axial section thereof greater than 0;
a holder connected to the barrel;
an image sensor module disposed at an image side of the optical elements; and
a circuit board electrically connected to the image sensor module and fixed on the holder.

7. The camera module as claimed in claim 6, wherein the optical elements are lenses.

8. The camera module as claimed in claim 6, wherein the barrel is connected to the holder via screw threads.

9. The camera module as claimed in claim 6, wherein the inner side of the spacer is a convex configuration.

10. The camera module as claimed in claim 6, wherein the inner side of the spacer is a concave configuration.
